(19) United States
(12) Patent Application Publication
(10) Pub. No.: US 2025/0109726 A1
(43) Pub. Date: Apr. 3, 2025

(54) INTEGRATED AIR FILTRATION VEHICLE FRAME COMPONENT

(71) Applicant: Bombardier Recreational Products, Inc., Valcourt (CA)

(72) Inventor: Juha MARTIKAINEN, Rovaniemi (FI)

(21) Appl. No.: 18/898,998

(22) Filed: Sep. 27, 2024

Related U.S. Application Data
(63) Continuation of application No. 63/586,340, filed on Sep. 28, 2023.

(51) Int. Cl. F02M 35/02

(52) U.S. Cl. CPC F02M 35/0205; F02M 35/0202

(57) ABSTRACT

An air filtering device comprises a frame configured for mounting to a vehicle, the frame having an outer surface, an inner surface, and a thickness interconnecting the outer surface to the inner surface. The exemplary air filtering device may comprise a continuous filter disposed in the frame such that the continuous filter is separated into a plurality of filter sections exposed through the frame.

### CROSS REFERENCE TO RELATED APPLICATIONS

This application claims the benefit of priority to U.S. Provisional Application No. 63/586,340 filed Sep. 28, 2023, the subject matter of each of which being incorporated herein by reference in its entirety.

### FIELD OF THE INVENTION

The present invention relates to intake manufacturing methods and mechanisms for vehicles designed to traverse rough and/or uneven terrain, such as snowmobiles, ATVs, personal watercraft and the like.

### BACKGROUND

Recreational vehicles may have one or more air flow passages, alternatively referred to as air intakes, that may be used for air entry into one or more devices located internally of the vehicle, such as, for example, internal combustion engines, continuously variable transmissions, heat exchangers, etc. Due to conventional use of recreational vehicles in wet, dusty, and/or unclean environments, it is important to filter the air received from outside of the vehicle when it is finally received at points within the vehicle, such as the engine or transmission to limit and/or prevent debris in the air from damaging those components.

The use of hydrophobic air intakes is known, as may be seen with reference to FIG. 28 and its related disclosures in U.S. Pat. No. 11,391,361 (the “'361 Patent”). The '361 Patent provides that screens 365 and 366, as illustrated in FIG. 28, are made of a hydrophobic mesh material to prevent not only dust but also at least a portion incoming dust and/or water, as the case may be, contained in the air from passing through the air intake assembly apertures 156, 158.

While screens, like the ones in the '361 Patent may be molded into the aesthetics of the particular vehicle in question, the labor and time needed to mold a screen at every air intake inlet about the vehicle is time consuming and adds a layer of complexity to the aesthetic fabrication process. For example, for air intakes located in different planes/surfaces of the vehicle, a separate filter would need to be held in place and adhered to the particular structure.

Furthermore, individualized screens, like those in the '361 Patent, tend to create weak points in the overall molding due to the fact that the screens are moored to only the perimeters of the structures in which they are found.

### SUMMARY

An exemplary air filtering device may comprise a frame configured for mounting to a vehicle that has an outer surface, an inner surface, and a thickness interconnecting the inner surface to the outer surface. The exemplary air filtering device may further comprise a continuous filter disposed in two unique planes within the thickness of the frame. The exemplary air filtering device may further comprise a continuous filter comprising a plurality of filter sections such that at least one of the plurality of filter sections is located in only one of the two unique planes and at least another of the plurality of filter sections is located in the other one of the two unique planes. The exemplary air filtering device may comprise may be further configured such that each of the plurality of filter sections is exposed through at least a portion of the thickness of the frame in which it is disposed and separated from another of the plurality of filter sections by a portion of the frame.

An exemplary air filtering manufacturing method may comprise the following steps (a) applying a continuous filter to a plurality of surfaces of a first mold; (b) combining the first mold with a second mold to substantially inhibit the presence of a thermoformable resin onto a plurality of portions of the continuous filter; (c) injecting the thermoformable resin into the combined first mold and second mold; and (d) producing the air filtering device with the plurality of portions of the continuous filter not embedded therein.

In addition to the previously described embodiment and/or as an alternative to any other described exemplary embodiment, an exemplary air filtering device may further comprise a plurality of filter regions disposed within the thickness of the frame.

In addition to the previously described embodiment and/or as an alternative to any other described exemplary embodiment, an exemplary air filtering device may further comprise a plurality of filter portions disposed within the thickness of the frame.

In addition to the previously described embodiment and/or as an alternative to any other described exemplary embodiment, an exemplary air filtering device may further comprise a plurality of filter regions disposed within the thickness of the frame.

In addition to the previously described embodiment and/or as an alternative to any other described exemplary embodiment, an exemplary air filtering device manufacturing method may further comprise the step of clamping the continuous filter between the first mold and the second mold in substantially the same formation as at least one of the plurality of portions.

In addition to the previously described embodiment and/or as an alternative to any other described exemplary embodiment, an exemplary air filtering device manufacturing method may further comprise the step of disposing the air filtering device on a vehicle.

In addition to the previously described embodiment and/or as an alternative to any other described exemplary embodiment, an exemplary air filtering device may be configured such that the continuous filter is hydrophobic.

In addition to the previously described embodiment and/or as an alternative to any other described exemplary embodiment, an exemplary air filtering device may be configured such that each of the plurality of filter sections is located in a unique plane of the frame.

In addition to the previously described embodiment and/or as an alternative to any other described exemplary embodiment, an exemplary air filtering device may be configured such that each of the plurality of filter sections is exposed through the thickness of the frame.

In addition to the previously described embodiment and/or as an alternative to any other described exemplary embodiment, an exemplary air filtering device may be configured such that each of the filter regions extends a distance into the thickness of the frame that is equivalent to 10-60% of the width of the most proximal filter section.

### DESCRIPTION OF THE DRAWINGS

FIG. 1 illustrates an exemplary prior art air intake system constructed according to prior molding and designs.

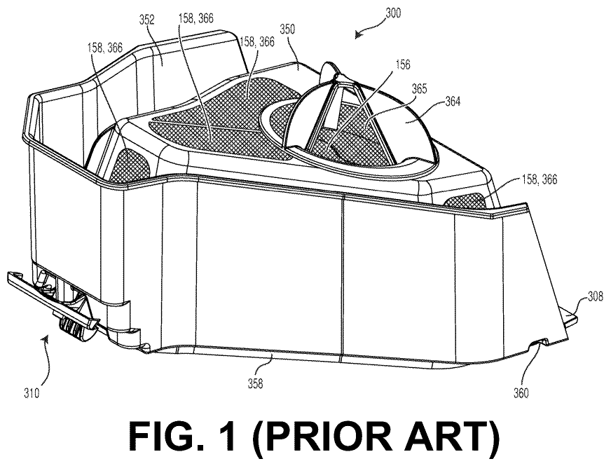

FIG. 2 illustrates an exemplary inventive structure as may be used on a vehicle configured to travel over snow.

FIG. 2A illustrates the exemplary air intake structure configured for placement on the exterior of a vehicle as shown in FIG. 2.

FIG. 2B illustrates an exemplary cross-sectional view along the length of the structure depicted in FIG. 2A.

FIG. 2C illustrates an exemplary cross-sectional view along the width of the structure depicted in FIG. 2A.

FIG. 3 illustrates another exemplary embodiment of an air intake structure configured for placement on the exterior of a vehicle.

FIGS. 4A-B each illustrates exemplary components of an exemplary air intake structure.

FIGS. 5A-B each illustrates exemplary components for the manufacture of an exemplary air intake structure.

In the drawings like characters of reference indicate corresponding parts in the different and interchangeable and interrelated figures. Parts and components of each figure may be substitutes for other components in other figures to achieve the various methods and embodiments disclosed herein. Methods and protocols disclosed in any embodiment may be run in any order so as to affect their disclosed goals and/or enable performance of the systems as described. Additionally, any one embodiment may utilize any method or protocol described and in any portions, sequences, and combinations thereof.

### DETAILED DESCRIPTION

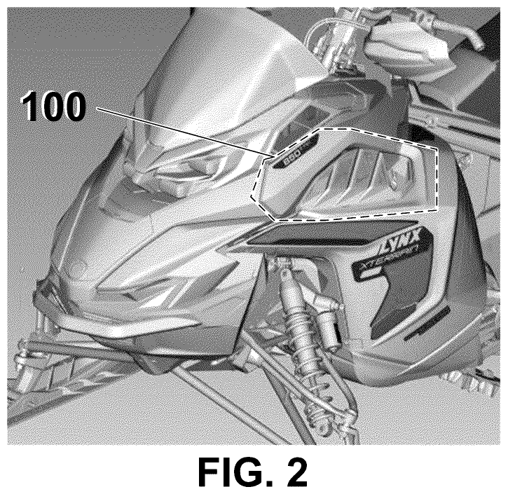

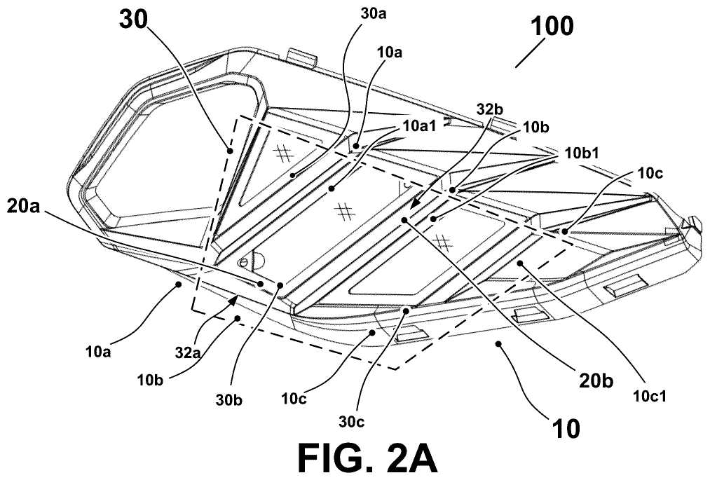

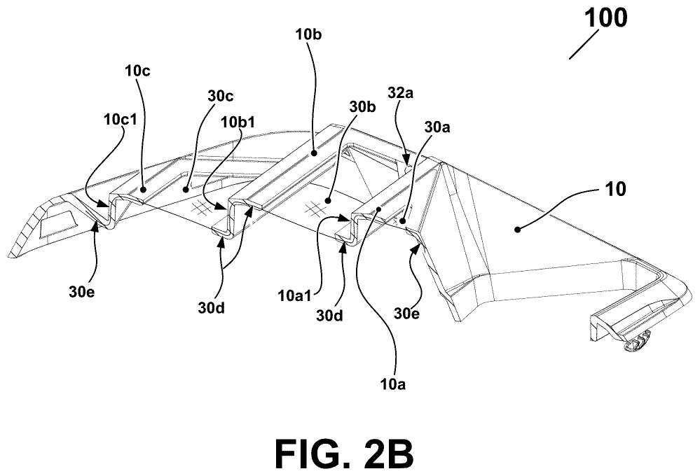

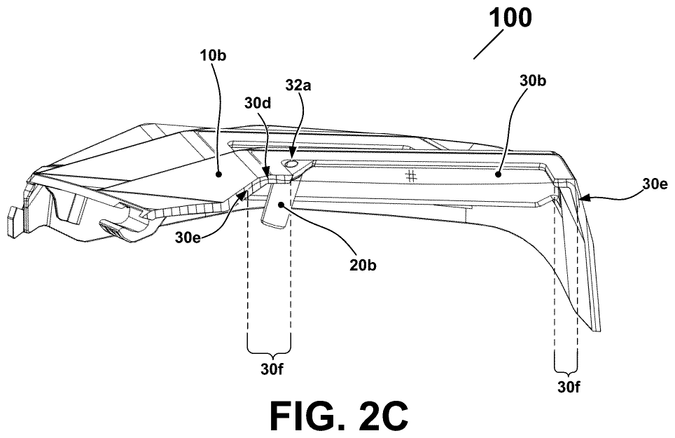

Referring to FIGS. 2A-C, an exemplary vehicle exterior component 100 may be one or more of the following: a fender, cowling, hood, or any equivalent structure designed to be on the outside of a vehicle and/or contribute to its aesthetic appearance to the end user. An exemplary vehicle exterior component 100 may be located on a vehicle, such as a snowmobile, all-terrain vehicle, personal water craft, bike, boat, or other such vehicle designed for heavy interaction with dirt, water, mud and the like. In an exemplary embodiment, exterior component 100 may be found on a snowmobile as illustratively provided for in FIG. 2. An exemplary exterior component 100 may be composed of plastic, sheet metal, or other known materials for fabrication under the circumstances of use and implementation.

Exterior component 100 may comprise a frame 10 comprising multiple different surfaces 10a, 10b, and 10c, each located in a unique plane with respect to the next. In an exemplary embodiment, surface 10a may be located further away from the vehicle to which exterior component 100 may be used as compared to surface 10b, and surface 10b may be located further away from the vehicle to which exterior component 100 may be used as compared to surface 10c. Common to all surfaces 10a-b may be a single hydrophobic filter 30 separated into sections 30a, 30b, and 30c via a combination of surfaces 10a-b and faces 10a1, 10b1, and 10c1. Filter 30 and its various sections 30a-c may act as barriers, including hydrophobic barriers, to the air intake portions 20a and 20b disposed on, within, or via frame 10 of exterior component 100. In an exemplary embodiment, signature openings 32a-b may be located in one or more portions of filter 30, such as, for example, section 30b. Exemplary signature openings 32a-b may be the apertures in filter 30 where it was held in place to the mold 200/300 to enable it to be over-molded with the plastic of frame 100 during the manufacturing process that yields component 100.

As may be understood with reference to FIGS. 2B-C, an exemplary filter 30 may be integrally molded at regions 30d of exterior component 100 (as shown in these illustrative embodiments, the filter 30 thickness may be identified by arrows from annotation 30d). As may be illustrated, a continuous filter 30 may be found within the plurality of regions 30d that are embedded within exterior component 100 while filter sections 30a, 30b, and 30c may be exposed exterior of component 100. An exemplary aspect of the technology herein described is to allow a plurality of sections of filter 30 to be located in different planes from one another (e.g., sections 30a-c being located in the planes of surfaces 10a, 10b, and 10c and separated by faces 10a1, 10b1, and 10c1, respectively) while simultaneously being continuously embedded via regions 30d to the exterior component 100 in which it may be found.

In an exemplary embodiment, where a portion 30e of an exemplary filter 30 is not otherwise coupled to another filter section (e.g., the portion 30e of filter sections 30a and/or 30c as illustrated in FIGS. 2B-C), an exemplary portion 30e may extend a distance 30f, which may be between 10% and 60% of the exposed width of the section 30a-c to which it is most proximally coupled into the thickness of the adjacent surface 10a and/or 10c, respectively, of the frame 10 of the exterior component 100. In an exemplary embodiment, every portion 30e and/or region 30d may extend the same distance 30f into the thickness of frame 10. In an exemplary embodiment, the region 30d may extend a distance through frame 10 that is substantially the same length as distance 30f.

One exemplary advantage of the above and illustrated embodiments is to provide a single filter 30, which may be hydrophobic, that is sufficiently anchored in the exterior component 100 without further cutting of the filter 30 into discrete portions. Another exemplary advantage of the above and illustrated embodiments is to provide a filter 30 that may be integrated with the material of exterior component 100 to both increase the rigidity of the exterior component 100 but further increase the robust connection between filter 30 and the remainder of the exterior component 100 and vehicle in which it may be found.

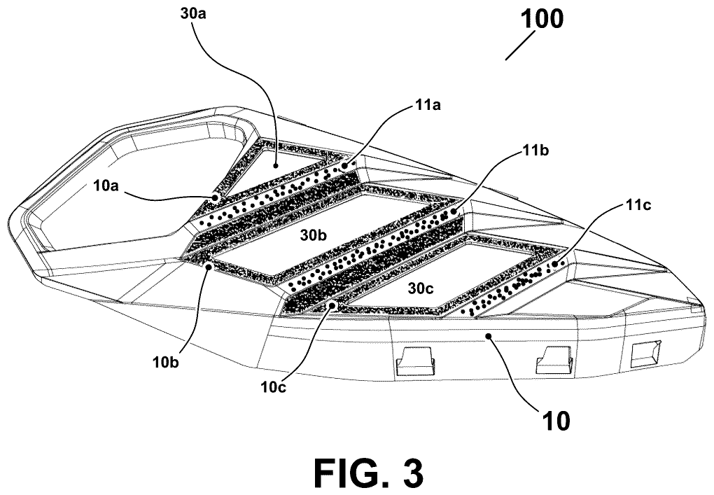

With reference to the illustrative embodiment of FIG. 3, an exemplary component 100 may be illustrated such that the viewer can depict different surface roughness about the component 100. In an exemplary embodiment, the plain white spaces between the lines of the illustration of FIG. 3 may refer to areas of uniform roughness. For example, the surfaces annotated by 10 may refer to a smooth, plastic finish acceptable for use on recreational vehicles, whereas the surfaces 10a/10b/10c may be a different surface finish, e.g., BM42105, that is configured to be similar in the smoothness of surface designed by annotation 10, but still able to hide the filter fabric 30a/30b/30c, respectively, in the event it were to migrate closer to the surface during injection molding. Additionally, surfaces 11a/11/b/11c may be a completely different type of surface finish, e.g., MT11315, or any other surface finish used elsewhere on component 100, including surfaces 10 and/or 10a/10b/10c. Thus, in an exemplary embodiment, the black-colored portions, such as those portions annotated 10a, 10b, and 10c, may denote surfaces with a different roughness from the remainder of the component 100 due to the embedded filter material 30 in those areas. The spotted portions, such as those portions 11a, 11b, and 11c, may denote the same roughness as the surfaces annotated 10a, 10b, and 10c and/or be a different roughness to adequately conceal any wrinkled or deflected filter fabric 30 from the surface of the molded component 100 frame 10.

According to another exemplary aspect of the filter embodiments herein described is that the cut-out and/or removal of filter material to form at least two legs interconnecting the otherwise continuous filter portions may aid the manufacturing and final component formed using the embedded continuous filter material therein. For example, the portions of the continuous filter material that would otherwise be disposed in the regions of the molds that indicate a change in surfaces of the frame are relatively without guide surfaces and/or retention mechanisms, which increases the prospect that these portions can move and displace to a degree that interferes with the molding process or causes portions of the continuous filter material to be seen through the mold. It has been surprisingly discovered that by removing material in these surface transitions, e.g., the cut-outs and/or windows, and simultaneously using the legs to maintain filter continuity substantially reduces the risk of displacement of the total filter during molding of the same into the component.

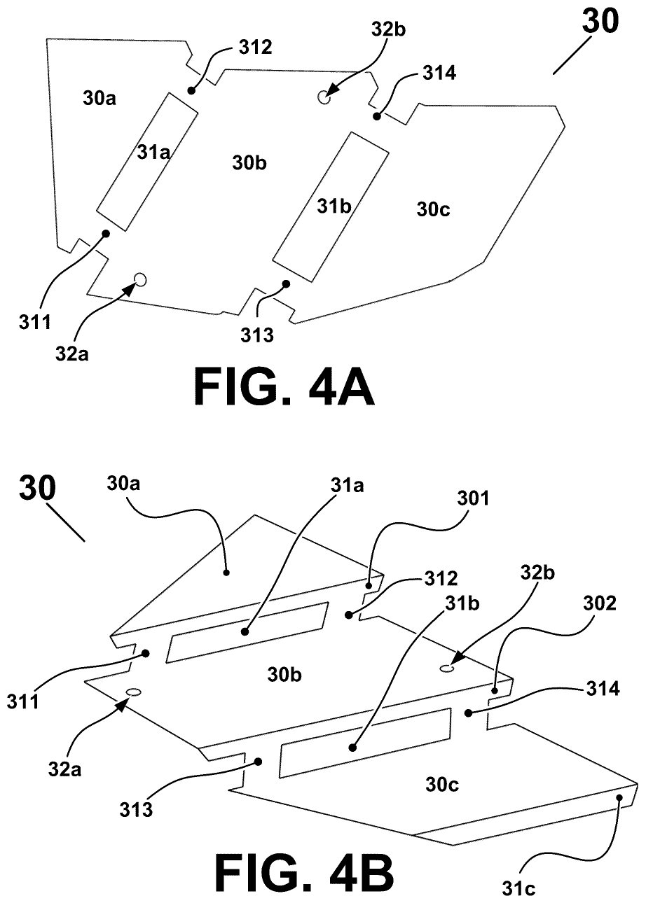

Therefore, according to an exemplary embodiment as may be illustrated in FIGS. 4A-B, an exemplary filter 30 may have portions removed from it to form cut-outs or windows 31a and 31b in the filter material 30. The windows 31a and 31b of filter 30 material may be those portions of the continuous filter that may be bent orthogonal to any air passages and/or molded into the parts of the frame that deviate from one surface to the next. In an exemplary embodiment, the windows 31a and 31b of filter material 30 may be found between two legs 311-314 of the continuous filter material 30 that are either at or inwardly oriented from the periphery of the continuous filter material 30, as may be illustrated in FIGS. 4A-B. According to an exemplary aspect of this exemplary embodiment, the use of windows in the filter material increases the resistance to stress by the continuous air filter material on the air passage portions and ensure a flat orientation throughout the process so that the respective edges cannot be seen through the plastic or material making up the frame.

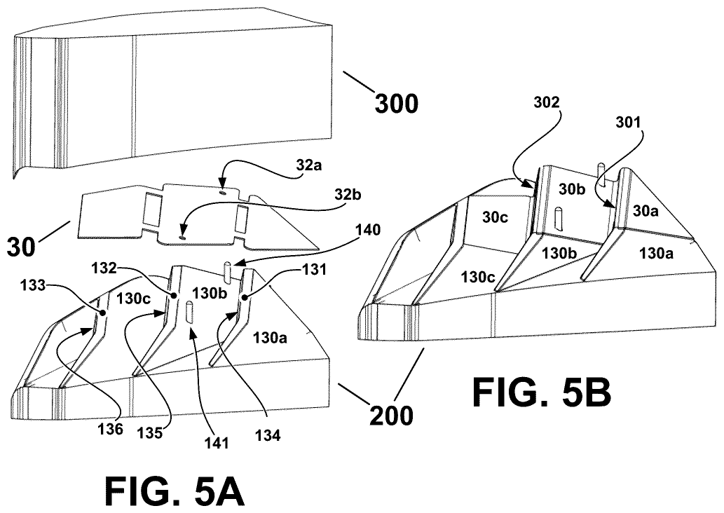

With reference to FIGS. 4A-B and 5A-B, an exemplary continuous filter 30 may be laid atop a mold base 200 prior to closure by mold top 300. FIG. 4A and FIG. 5A each show a filter 30 in a relaxed, pre-mold retention state. The filter portions 30a, 30b, and 30c may be illustrated with interconnections via legs 311-314 and cut-outs 31a and 31b. Further illustrated may be signature openings 32a and 32b in an exemplary filter portion 30b. FIG. 4B and FIG. 5B may illustrate an exemplary filter 30 as it is retained in an exemplary mold base 200. With reference to FIG. 4B, an exemplary retained filter 30 may be configured in a stepwise fashion that causes folding of a plurality of portions of the filter 30 to enable the same to be retained within a molded component 100 with reduced visibility in those areas meant for only plastic to show. For example, as illustrated in FIG. 4B, an exemplary retained filter 30 may comprise a portion 30a that has been folded, creased, or deflected into a sub-portion 31a whereby sub-portion 301 may be in a different plane than the portion 30a. Coupling the sub-portion 31a, much like the portion 30a, to the next portion of the filter, 30b, may be two legs 311 and 312 that are separated from one another by a cut-out 31a. As further illustrated in FIG. 4B, an exemplary filter 30 portion 30b may be in the same plane, a parallel plane, or a slightly offset plane from the one in which another portion of filter 30 may be found (e.g., portions 30a or 30c). Alternatively, exemplary filter 30 portion 30b may be in a plane substantially orthogonal or otherwise angled with respect to sub-portions 301 and/or 302. Similar to portion 30a, portion 30b may also have a sub-portion 302 that may be the result of folding, creasing, or deflecting a part of portion 30b. Likewise, sub-portion 302 interconnects portion 30b to portion 30c via legs 313 and 314. Legs 313 and 314 may be separated from one another via a cut-out 31b. Portion 30c may further have a sub-portion 31c. Like their respective portions 30b and 30c from which they are made, sub-portions 31b and 31c may be in off-set planes from those of their respective portions, 30b and 30c, and, in an exemplary embodiment, may be in substantially orthogonal alignment with the same.

Referring more specifically to the illustrative embodiments of FIGS. 5A-B, an exemplary filter 30 for use in an exemplary component 100 may be placed atop a mold base 200 so that its signatures openings 32a and 32b align with alignment pins 140 and 141, respectively. In an exemplary embodiment, pins 140 and 141 may restrain the signature openings 32a/32b at a distance above the mold base 200 surface to allow for plastic to be injected bother below and above the exposed filter 30 fabric destined for being embedded in the eventual component frame. Moreover, landings 130a, 130b, and 130c may have stepped contours 131, 132, and 133, respectively, adjacent to ledges 134, 135, and 136, respectively to enable the stepwise conformation of the filter 30 as it may be designed to fit within component 100. As shown in FIG. 5B, an exemplary filter 30 may be placed into a configuration substantially similar to that in FIG. 4B, when resting on top of mold base 200. Those skilled in the art would understand the contours, gates, sprues, and runners necessary to convert the at-rest filter 30 found on a mold base 200 into the final component 100 using the mold top 300. In an exemplary embodiment, the mold top 300 may be a part of a vertical mold operation involving filter 30.

When closed within the mold assembly formed of 200 and 300, the continuous filter 30 may be surrounded by mold surfaces (not shown) that do not receive any injected material thereon, e.g., plastic or other thermoformable resin. Once injection of the material to make the frame has taken place, release of the molds may produce a molded part with intermittent portions of the continuous filter to be exposed for use with air filtration. Those skilled in the art would understand various ways to anchor the continuous filter within the mold while also preserving its form (e.g., avoid rippling) and preserving its air filtration properties (e.g., hydrophobicity).

Many further variations and modifications may suggest themselves to those skilled in art upon making reference to above disclosure and foregoing interrelated and interchangeable illustrative embodiments, which are given by way of example only, and are not intended to limit the scope and spirit of the interrelated embodiments of the invention described herein.

1. An air filtering device, comprising:
a frame configured for mounting to a vehicle, the frame having an outer surface, an inner surface, and a thickness therebetween; and
a continuous filter disposed in two unique planes within the thickness of the frame, the continuous filter comprising a plurality of filter sections, wherein at least one of the plurality of filter sections is located in only one of the two unique planes and at least another of the plurality of filter sections is located in the other one of the two unique planes,
wherein each of the plurality of filter sections is exposed through at least a portion of the thickness of the frame in which it is disposed and separated from another of the plurality of filter sections by a portion of the frame.

2. The air filtering device of claim 1, wherein each of the plurality of filter sections is located in a unique plane of the frame.

3. The air filtering device of claim 2, wherein each of the plurality of filter sections is exposed through the thickness of the frame.

4. The air filtering device of claim 3, wherein the continuous filter is hydrophobic.

5. The air filtering device of claim 1, wherein the continuous filter is hydrophobic.

6. The air filtering device of claim 2, wherein the continuous filter is hydrophobic.

7. The air filtering device of claim 1, further comprising a plurality of filter regions disposed within the thickness of the frame.

8. The air filtering device of claim 1, further comprising a plurality of filter portions disposed within the thickness of the frame.

9. The air filtering device of claim 8, further comprising a plurality of filter regions disposed within the thickness of the frame.

10. The air filtering device of claim 1, wherein each of the filter regions extends a distance into the thickness of the frame that is equivalent to 10-60% of the width of the most proximal filter section.

11. The air filtering device of claim 1, wherein at least one filter region extends a distance into the thickness of the frame that is equivalent to 10-60% of the width of the most proximal filter section.

12. The air filtering device of claim 9, wherein each of the filter regions extends a distance into the thickness of the frame that is equivalent to 10-60% of the width of the most proximal filter section.

13. The air filtering device of claim 9, wherein at least one filter region extends a distance into the thickness of the frame that is equivalent to 10-60% of the width of the most proximal filter section.

14. A method of manufacturing an air filtering device, comprising the steps of applying a continuous filter to a plurality of surfaces of a first mold;
combining the first mold with a second mold to substantially inhibit the presence of a thermoformable resin onto a plurality of portions of the continuous filter;
injecting the thermoformable resin into the combined first mold and second mold; and
producing the air filtering device with the plurality of portions of the continuous filter not embedded therein.

15. The method of claim 14, further comprising the step of clamping the continuous filter between the first mold and the second mold in substantially the same formation as at least one of the plurality of portions.

16. The method of claim 15, further comprising the step of disposing the air filtering device on a vehicle.

17. The method of claim 14, further comprising the step of disposing the air filtering device on a vehicle.

18. The method of claim 14, wherein the continuous filter is hydrophobic.

19. The method of claim 15, wherein the continuous filter is hydrophobic.

20. The method of claim 17, wherein the continuous filter is hydrophobic.
